(19) United States
(12) Patent Application Publication
(10) Pub. No.: US 2009/0183194 A1
(43) Pub. Date: Jul. 16, 2009

(54) METHODS AND APPARATUS TO HANDLE TELECOMMUNICATION SERVICE CHANGES

(76) Inventor: Michael Raftelis, San Antonio, TX (US)

Correspondence Address: AT&T Legal Department - HFZ;ATTN. Patent Docketing, One AT&T Way, Room 2A-207, Bedminstor, NJ, 07921, US

(21) Appl. No.: 11/972,076

(22) Filed: Jan. 10, 2008

(51) Int. Cl. H04N 7/16; G06Q 10/00

(52) U.S. Cl. 725/25; 705/1

(57) ABSTRACT

Methods and apparatus for handling telecommunication service changes are described. An example apparatus includes a service indicator receiver to receive a first service indicator for a first service and to receive a second service indicator different from the first service indicator for a second service, a converter to convert the first service indicator into a first set of service rules for the first service, to convert the second service indicator into a second set of service rules for the second service, and a rule transmitter to send the first set of service rules and the second set of service rules to a network element.

### FIELD OF THE DISCLOSURE

This disclosure relates generally to telecommunications and, more particularly, to methods and apparatus to handle telecommunication service changes.

### BACKGROUND

Service providers that offer multiple services often allow consumers to select any desired combination of services. An example telecommunications service provider allows consumers to select any desired combination of services among a voice over internet protocol service, an internet protocol television service, and a high speed internet access service. A consumer can request a desired combination of services when registering for the service and/or can request modification of selected services at another time.

A technique for restricting usage of a service provider network is the use of filters. Filters include rules that either allow or deny communications matching predetermined criteria. Filter can also include exceptions based on time of day, promotions offered by a service provider, etc. An example rule prevents all communications from consumers directed to a particular server on a designated port. Service providers manually develop a set of rules for each possible combination of services. For example, a service provider that allows consumers to choose to enable or disable four separate services creates sixteen sets of rules. The number of sets of rules created increases rapidly when consumers are allowed to select among different service levels for the different services. For example, if a service provider allows consumers to select one of four service levels for each of four services, the service provider would create 256 sets of rules. Then, when a consumer registers for a combination of services, the appropriate set of rules for the combination is selected.

### BRIEF DESCRIPTION OF THE DRAWINGS

FIG. 1 is a block diagram of an example system for handling telecommunication subscription requests in a telecommunication service provider network.

FIG. 2 is a block diagram of an example implementation of the translator of FIG. 1.

FIG. 3 illustrates example machine-readable instructions that are executed to implement the methods and apparatus disclosed herein.

FIG. 4 is a flowchart illustrating example machine readable instructions to implement a translator.

FIG. 5 illustrates an example table of rules data that may be included in the example rules database of FIG. 2.

FIG. 6 is a schematic diagram of an example processor platform that may be used and/or programmed to implement the apparatus disclosed herein.

### DETAILED DESCRIPTION

Methods and apparatus to handle telecommunication subscription requests for a service provider are disclosed herein. A disclosed example translator receives identifications and parameters for users ordering services. Based on the identifications and parameters, the translator retrieves and sorts rules associated with the ordered services. For example, in an example method, a base set of rules are retrieved, followed by voice over internet protocol (VoIP) phone rules, followed by rules for suspending services, followed by rules for video services, and followed by rules for high speed internet access (HSIA). After the rules are retrieved by the translator, the rules are transmitted to a service provider network element that manages distribution of the rules to the service provider's network. For example, a policy manager distributes rules to a residential gateway at a consumer location.

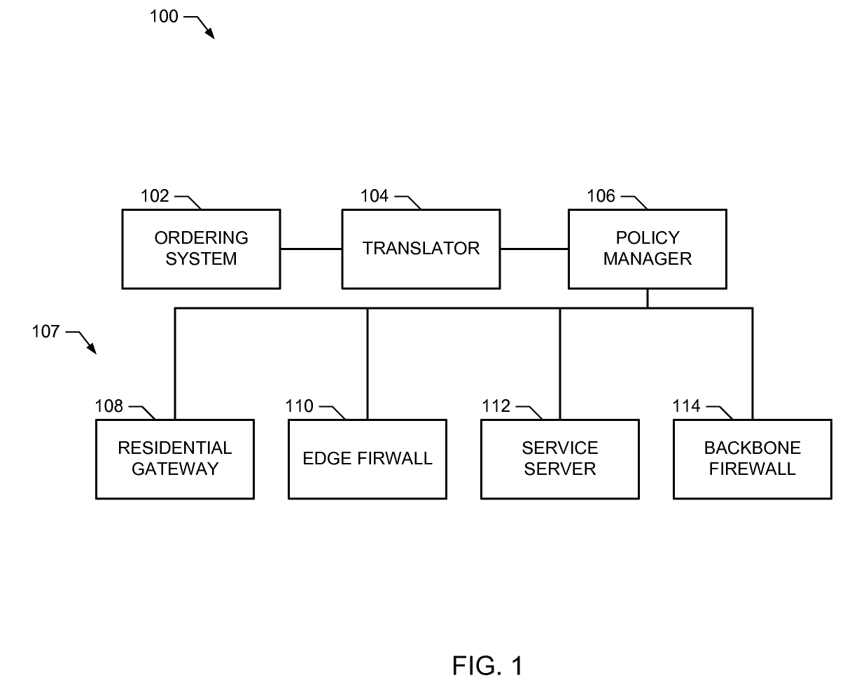

FIG. 1 is a block diagram of an example system 100 for handling telecommunication subscription requests in a telecommunication service provider network. The example system 100 includes an ordering system 102, a translator 104, a policy manager 106, a residential gateway 108, a edge firewall 110, a service server 112, and a backbone firewall 114.

The ordering system 102 of the illustrated example includes one or more servers for receiving ordering requests for access to telecommunication services. For example, the ordering system 102 may receive requests for access to internet services, television services, telephone services (e.g., access to public switched telephone network (PSTN) services and/or VoIP services), wireless services, etc. Requests to access telecommunication services may be received from users on the internet, may be input using an input device (e.g., a keyboard) at the ordering system 102, and/or may be received by the ordering system 102 from any other source. The ordering system 102 transmits information about received requests (e.g., service indications and parameters) to the translator 104. For example, the information about the received requests may include identifying information about the source of the request, network identification information associated with the request (e.g., user certificate, username, equipment identification numbers, serial numbers, etc.), information about services associated with the request (e.g., identifications associated with services to be added or removed by the request), etc.

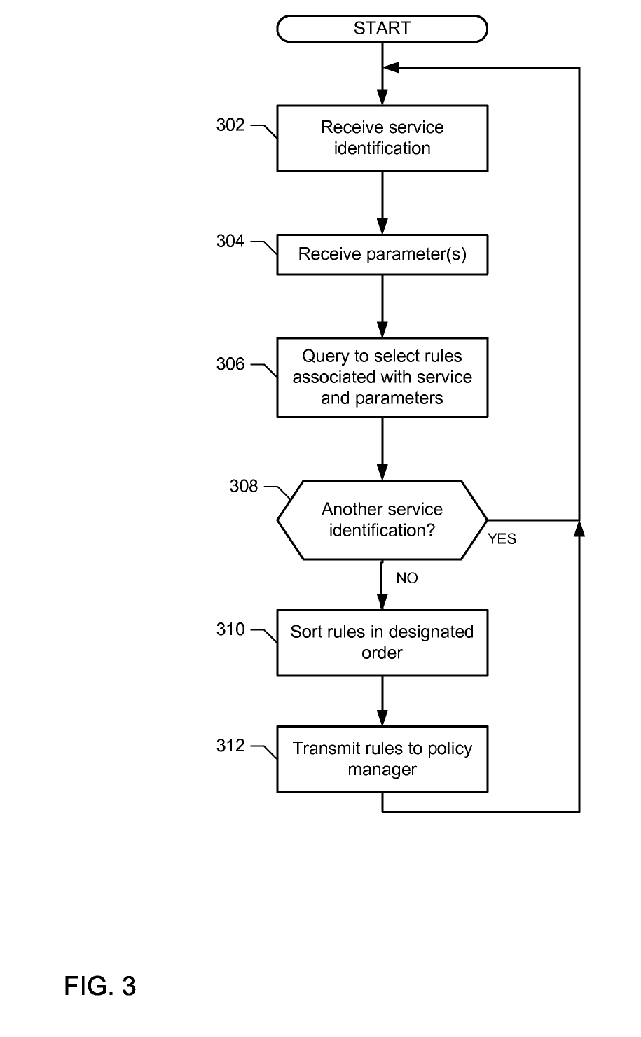

The translator 104 of the illustrated example receives information about ordering requests for telecommunication services from the ordering system 102. The example translator 104 converts the information about ordering requests into filtering rules. In an example implementation, the translator 104 receives a user identification, a service identification, and a parameter associated with HSIA service and an identification associated with television service. In response, the translator prepares a first set of rules related to the HSIA service based on the parameter (e.g., a parameter indicating a service level) and a second set of rules related to television service. An example flowchart illustrating machine readable instructions that may be used to implement the example translator 104 are shown in FIG. 3.

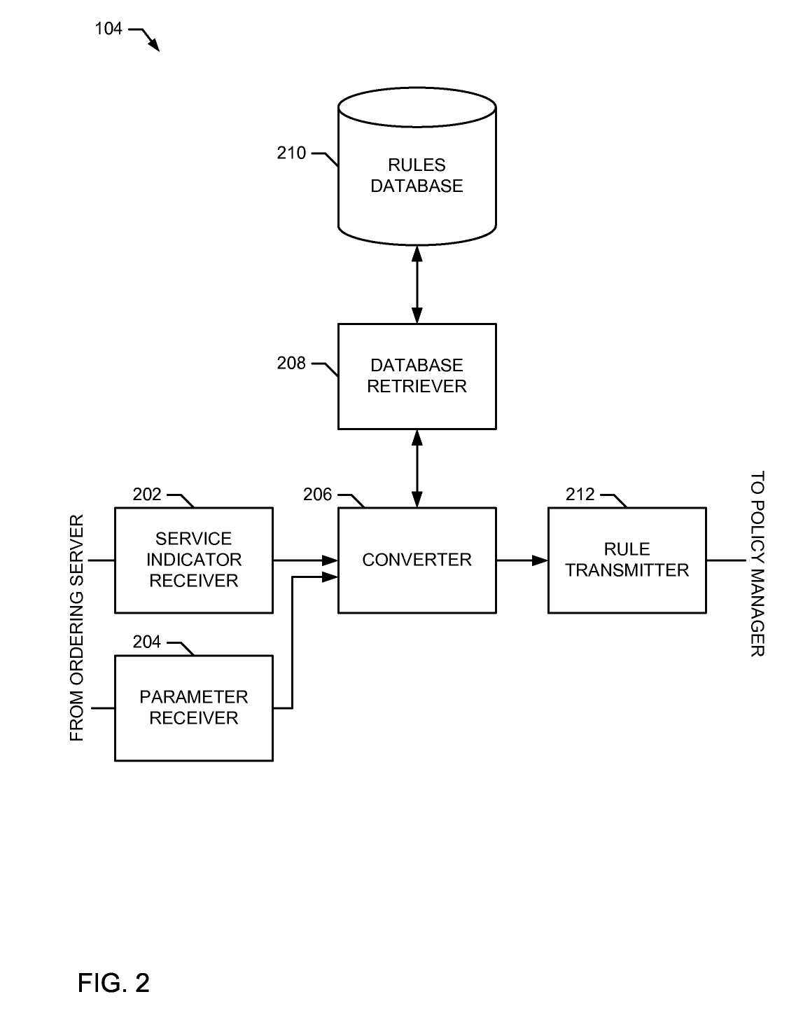

In addition to preparing rules based on received information about ordering requests, the example translator 104 prepares a base set of rules. In the example implementation, the base set of rules are applied regardless of the services identified in an ordering request. For example, the base set of rules may include rules for preventing viruses and/or service tampering. The translator 104 prioritizes the rules and transmits them to the policy manager 106. The translator 104 is described in further detail in conjunction with FIG. 2.

The policy manager 106 of the illustrated example is a service provider network element that receives and stores the rules compiled for a subscriber from the translator 104. The example policy manager 106 manages communication sessions for network devices 107 (the residential gateway 108, the edge firewall 110, the service server 112, and the backbone firewall 114). The example policy manager 106 may distribute appropriate rules to the network devices 107 and/or may respond to authorization queries. For example, the policy manager 106 may receive an identification from the residential gateway 110 connected to a particular physical port at the central office 110. In response, the policy manager may submit the rules associated with the particular physical port and residential gateway (e.g., based on a user identification) to the residential gateway.

The network devices 107 are representative of devices on a network that may communicate with the policy manager 106. While the illustrated example includes the residential gateway 108, the edge firewall 110, the service server 112, and the backbone firewall 114, a particular implementation may include any number of network devices and any other types of network devices such as routers, subscriber management elements, cross connects.

The residential gateway 108 of the illustrated example is located at a consumer location and connects the consumer location to a service provider's network. According to the illustrated example, the residential gateway 108 is an asynchronous digital subscriber line (DSL) (ADSL) terminal unit—remote (ATU-R) that may be connected to a DSL access multiplexor (DSLAM) at a central office (e.g., a central office that includes the edge firewall 110). However, the residential gateway 108 may be any type of network interface device such as a cable modem, a satellite modem, an Ethernet adapter, etc.

The residential gateway 108 of the illustrated example enforces rules received from the policy manager 106. For example, the residential gateway 108 may prevent a user that has cancelled their service from accessing the network or may prevent requests from the network on a restricted port from reaching the user. The example residential gateway 108 is associated with a user identification associated with the service location. For example, the example residential gateway 108 stores a user certificate and forwards the user certificate to the policy manager when requesting initiation of a telecommunication session.

The edge firewall 110 of the illustrated example is a firewall device at a network edge (e.g., a firewall at a central office of a service provider network). The example edge firewall 110 interposes between the devices connected to the central office (e.g., the residential gateway 108) and the remainder of the service provider network. The example edge firewall 110 enforces rules received from the policy manager 106. For example, the edge firewall 110 may enforce rules specific to a particular user, a particular set (e.g., a class) of users, and/or may enforce rules for all connections.

The service server 112 of the illustrated example is a server that provides some service to users of the network. For example, the service server 112 may serve video on demand content, may serve voicemail services, may serve internet protocol television (IPTV) media content, may serve internet protocol (IP) addresses to users as a dynamic host control protocol (DHCP) server, etc. The example service server 112 enforces rules received from the policy manager 106. For example, the service server 112 may enforce rules that deny access to the service server 112 to prevent unauthorized users or malicious attacks from gaining access to the service server 112.

The backbone firewall 114 of the illustrated example interposes between the service provider's network and the backbone connection to the internet. The example backbone firewall 114 enforces rules received from the policy manager 106. For example, the backbone firewall 114 may prevent unauthorized communication sessions from accessing the backbone connection, may prevent unauthorized connections from reaching the service provider network from the backbone connection, etc.

FIG. 2 is a block diagram of an example implementation of the translator 104 of FIG. 1. The example implementation of the translator 104 comprises a service indicator receiver 202, a parameter receiver 204, a converter 206, a database retriever 208, a rules database 210, and a rule transmitter 212.

The service indicator receiver 202 of the illustrated example receives service identifications from an ordering system (e.g., the ordering system 102 of FIG. 1) and transmits the service identifications to the converter 206. The service indicator receiver 202 may be implemented by any type of communication device such as a wired network connection, a wireless network connection, a serial communication connection, a parallel communication connection, a fiber-optic connection, etc.

The parameter receiver 204 of the illustrated example receives parameters from an ordering system (e.g., the ordering system 102 of FIG. 1) and transmits the parameters to the converter 206. The parameter receiver 204 may be implemented by any type of communication device such as a wired network connection, a wireless network connection, a serial communication connection, a parallel communication connection, a fiber-optic connection, etc.

While the parameter receiver 204 and the service indicator receiver 202 are illustrated as separate components in FIG. 2, the parameter receiver 204 and the service indicator receiver 202 may alternatively be integrated into a single component.

The converter 206 of the illustrated example receives service identifications from the service indicator receiver 202 and parameters from the parameter receiver 204 and outputs rules based on those service identifications and parameters to the rule transmitter 212. Upon receipt of a service identification (e.g., a user identification and service type identifier) and one or more parameters (e.g., a content identifier, a destination address, etc.), the example converter 206 sends a request to the database retriever 208 requesting rules associated with the parameters and the specified service identification. The converter 206 then receives the rules identified by the database retriever 208.

The converter 206 of the illustrated example further arranges rules in a desired order. For example, it may be desirable for a base set of rules to be applied first, followed by rules for a VoIP service, followed by rules for suspending services, followed by rules for a video service (e.g., IPTV), followed by rules for HSIA. The order of rules controls how contradictory rules will affect services. In the forgoing example order of rules, a VoIP rule explicitly allowing (e.g., specifying affirmatively that communication should be permitted) minimal phone services (e.g., emergency 911 access) will prevail over a suspending service rule that denies access to services because the explicit rule will be processed first. As used herein, an explicit rule is a rule that specifically addresses a particular user, a specific service type, a specific communication device and/or a specific communication port. Once an explicit rule is encountered (e.g., at a residential gateway (e.g., residential gateway 108) while evaluating rules received from a policy manager (e.g., policy manager 106), no further rule processing on the same topic is performed. Therefore, the explicit “allow” VoIP rule that is invoked before encountering the suspend rule in the above example will ensure that a VoIP phone is not prevented from accessing emergency phone numbers.

In another example, if a first rule indicates that incoming communication on all communication ports is to be blocked (i.e., a non-explicit rule), but a second rule explicitly indicates that incoming communication on port 53 is to be allowed, the second (explicit) rule overrides the first (non-explicit) rule to enable communication on port 53. In other words, if the first rule is not an explicit rule, rules relating to the same topic will continue to be processed until and unless an explicit rule affecting the same topic is reached or all rules have been processed.

The database retriever 208 of the illustrated example receives requests for rules. Such requests include a service identification and may also include a parameter. In response, the example database retriever 208 retrieves the appropriate rules from the rules database 210. For example, if the service identification identifies HSIA service and the parameters indicate that HSIA service should be enabled at a first service level, the database retriever 208 will retrieve rules that are associated with the enabled HSIA service at the first service level. The example database retriever 208 sends the retrieved rule(s) to the converter 206.

The rules database 210 of the illustrated example stores rules associated with services offered by the service provider. The rules database 210 may be implemented by any type of data storage such as a database, a file, a collection of files, a hard disk drive, a removable storage, etc. The rules in the database may be stored in any format. In the illustrated example, the rules are stored as a data structure storing a service identification (e.g., a name or other handle identifying the service associated with the rule and the required parameters), the source IP address, a destination IP address, a port identification (e.g., a number of a port or ports, a wildcard, etc.), a protocol (e.g., TCP, UDP, etc.), and a rule designation (e.g., permit, deny). While a single rules database 210 is illustrated in FIG. 2, multiple databases or data stores may implement the rules database 210. For example, a first database may stores rules associated with a first service, a second database may stores rules associated with a second service, etc.

The rule transmitter 212 of the illustrated example receives rules from the converter 206 and transmits the rules to a policy manager (e.g., the policy manager 106 of FIG. 1). The rules transmitter 212 may be implemented by any type of communication device such as a wired network connection, a wireless network connection, a serial communication connection, a parallel communication connection, a fiber-optic connection, etc.

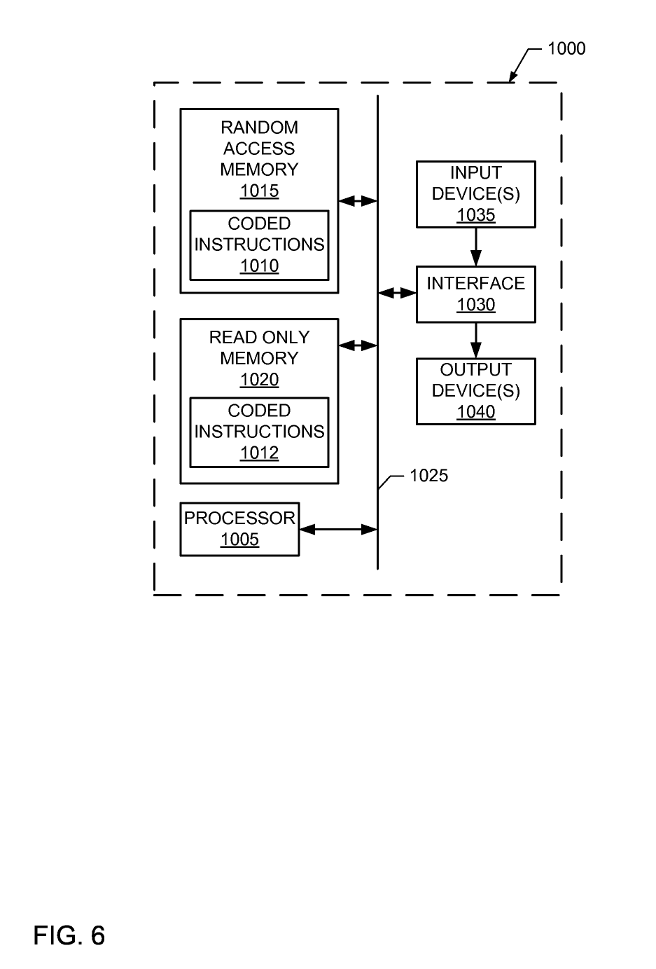

FIG. 3 illustrates example machine-readable instructions that are executed to implement the translator 104 of FIG. 1 including any or all of the service indicator receiver 202, the parameter receiver 204, the converter 206, the database retriever 208, the rules database 210, and the rule transmitter 212 of FIG. 2. The example machine-readable instructions of FIG. 3 may be carried out by a processor, a controller and/or any other suitable processing device. For example, the example machine-readable instructions of FIG. 3 may be embodied in coded instructions stored on a tangible medium such as a flash memory, a read only memory (ROM) and/or random access memory (RAM) associated with a processor (e.g., the example processor 1005 discussed below in connection with FIG. 6). Alternatively, some or all of the example machine-readable instructions of FIG. 3 may be implemented using any combination(s) of application-specific integrated circuit(s) (ASIC), programmable logic device(s) (PLD), field-programmable logic device(s) (FPLD), discrete logic, hardware, firmware, etc. Also, some or all of the example machine-readable instructions of FIG. 3 may be implemented manually or as any combination of any of the foregoing techniques, for example, any combination of firmware, software, discrete logic and/or hardware. Further, although the example machine-readable instructions are described with reference to the flowcharts of FIG. 3, many other methods of implementing the machine-readable instructions of FIG. 3 may be employed. For example, the order of execution of the blocks may be changed, and/or one or more of the blocks described may be changed, eliminated, sub-divided, or combined. Additionally, any or all of the example machine-readable instructions of FIG. 3 may be carried out sequentially and/or carried out in parallel by, for example, separate processing threads, processors, devices, discrete logic, circuits, etc.

FIG. 3 is a flowchart illustrating example machine readable instructions that may be used to implement a translator (e.g., the translator 104 of FIG. 1). The flowchart of FIG. 3 begins when a service identification is received by a translator (e.g., the translator 104 of FIG. 1) from an ordering system (e.g., the order server 102 of FIG. 1) (block 302). For example, the service identification may indicate that a designated user has signed up for HSIA. Then, the translator receives one or more parameters from the ordering system (block 304). For example, a parameter may indicate that the user has signed up for a first service level of HSIA (e.g., a downstream connection of 1.5 Mbps and an upstream connection of 384 kbps).

The translator then queries for rules associated with the received service identification and parameter(s) (block 306). For example, a converter (e.g., the converter 206 of FIG. 2) and a database retriever (e.g., the database retriever 208 of FIG. 2) may query a database of rules (e.g., the rules database 210 of FIG. 2). The translator then determines if there is another service identification to process for the designated user (block 308). If there is another service identification to process for the designated user, control returns to block 302 to process the next service identification.

If there is not another service identification to process for the designated user (block 308), the translator sorts the rules in a designated order. For example, the translator may sort the rules such that rules associated with VoIP are processed before rules associated with HSIA based on a higher priority associated with ensuring that VoIP services are available (e.g., for access to emergency 911 services). The sorting order for rules may be specified by an operator of the translator, an operator of the ordering system (e.g., a designation of the order may be transmitted from the order server to the translator), a user signing up for services using the ordering system, etc. Once the rules are sorted in the designated order, the rules are transmitted to a policy manager (e.g., the policy manager 106 of FIG. 1) (block 312).

After the translator transmits the rules to the policy manager (block 312), the translator will await receipt of another service identification (i.e., control will return to block 302). For example, the translator may receive a service identification for a second designated user.

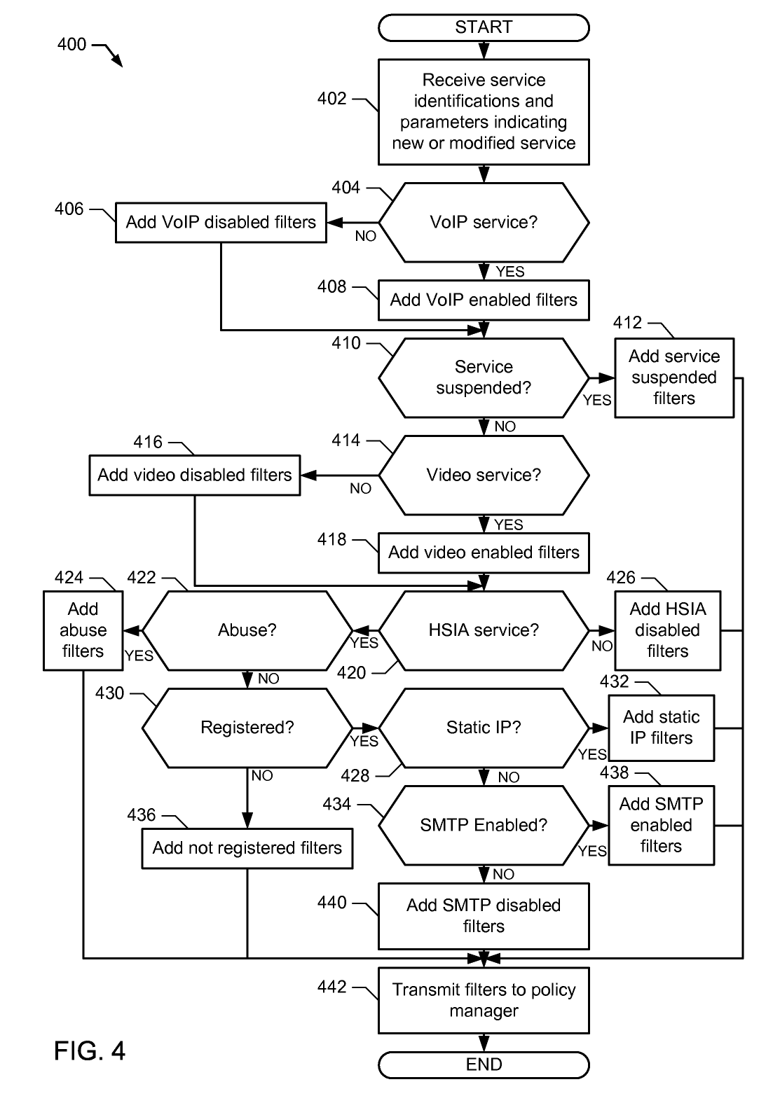

FIG. 4 is a flowchart illustrating example machine readable instructions to implement a translator (e.g., the translator 104 of FIG. 1). The example flowchart of FIG. 4 is a more detailed implementation of the flowchart of FIG. 3. The flowchart of FIG. 4 begins when the translator receives service identifications and parameters indicating that a user's services have been added or modified (block 402). The flowchart then determines if the service identifications and parameters indicate that the user has subscribed to VoIP service (block 404). If the user has not subscribed to VoIP service (block 404), the translator retrieves rules for disabling VoIP services for the user (e.g., the converter 206 obtains filter rules for disabling VoIP service from the rules database 210 using the database retriever 208) (block 406). Control then proceeds to block 410. In the illustrated example, rules for disabling VoIP services block any communications from the user to trivial file transfer protocol (TFTP) servers, VoIP portal servers, and session border controllers.

If the user has subscribed to VoIP service (block 404), the translator retrieves filter rules for enabling VoIP services (block 408). In the illustrated example, rules for enabling VoIP services explicitly permit communications from a user to VoIP services and block any communications from the user to TFTP servers, VoIP portal servers, and session border controllers.

The translator then determines if the service identifications and the parameters indicate that the user's services are suspended (block 410). In the illustrated example, user's services are suspended when, for instance, they have not paid their bill for a predetermined amount of time. If the user's services are suspended, the translator retrieves filter rules for suspended the user's services (block 412). Control then proceeds to block 442. In the illustrated example, rules for suspending a user's service drop all communications except for communications destined for domain name servers (DNS), network time protocol services, and/or DHCP servers.

If the translator determines that the user's services are not suspended (block 410), the translator determines if the service identifications and parameters indicate that the user has registered for video service (e.g., IPTV service) (block 414). If the translator determines that the user has not registered for video service (block 414), the translator retrieves rules for disabling video services (block 416). Control then proceeds to block 420. In the illustrated example, video services are disabled by blocking all communications from the user to video head office servers and devices.

If the translator determines that the user has registered for video services (block 414), the translator retrieves rules for enabling video services (block 418). In the illustrated example, the rules for enabling video services explicitly permit communications from a residential gateway to video head office servers and devices.

The translator then determines if the service identifications and parameters indicate that the user has signed up for HSIA (block 420). If the translator determines that the user is not signed up for HSIA (block 420), the translator retrieves rules for disabling HSIA (block 426). Control then proceeds to block 442. In the illustrated example, rules for disabling HSIA explicitly permit communications from a DHCP assigned address at a residential gateway destined for DNS, network time protocol services, and DHCP servers and block all other communications.

If the translator determines that the user is signed up for HSIA (block 420), the translator determines if the user's account or devices have been flagged for abusing the network (block 422). For example, a user's account may be flagged if the user has utilized more than a predetermined amount of bandwidth in a predetermined time. If the translator determines that the user's account or device(s) have been flagged for abuse (block 422), the translator retrieves rules designed for abusive accounts (block 424). Control then proceeds to block 442. In the illustrated example, rules designed for abusive accounts permit communications from a residential gateway or registered static IP address to customer premise equipment management servers, domain name servers, network time protocol servers, DHCP servers, and walled garden sites such as customer care sites and billing sites and block all other communications.

If the translator determines that the user's account and devices are not flagged for abuse (block 422), the translator determines if the service identifications and parameters indicate that the user is attempting to register for HSIA (block 430). If the translator determines that the user is attempting to register for HSIA (block 430), the translator retrieves filters that put the user in a registration mode (block 436). Control then proceeds to block 442. In the illustrated example, the filters that put the user in a registration mode explicitly permit communications from a residential gateway or registered static IP address to DNS, network time protocol servers, DHCP servers, one or more registration servers, and a white list of predetermined websites and block all other communications.

If the translator determines that the user has already registered for HSIA (block 430), the translator determines if the service identifications and parameters indicate that the user is registered for a static IP address (block 428). If the translator determines that the user has registered for a static IP address (block 428), the translator retrieves rules for enabling a static IP address for the user (block 432). Control then proceeds to block 442. In the illustrated example, rules for enabling a static IP address explicitly permit all unicast communications from a user or a residential gateway and block all other communications. In other words, while the example rules for enabling HSIA allow communications from a DHCP address on a residential gateway, the rules for enabling a static IP allow communications for a DHCP address and a registered static IP address.

If the translator determines that the user has not registered for a static IP address (block 428), the translator determines if the service identifications and parameters indicate that the user has registered for access to mail servers outside of the provider (e.g., simple mail transport protocol (SMTP) access) (block 434). If the translator determines that the user has registered for outside mail access (block 434), the translator retrieves rules for enabling mail access (block 438). Control then proceeds to block 442. In the illustrated example, rules for enabling extranet SMTP access explicitly permit unicast traffic from a DHCP address at a residential gateway and block all other communications.

If the translator determines that the user has not registered for outside mail access (block 434), the translator retrieves rules for blocking access to extranet mail servers. In the illustrated example, rules for blocking extranet SMTP access explicitly permit communications to an SMTP port for servers of the service provider, deny communications to the SMTP port on other servers, allow all other unicast communications, and block all remaining communications.

After the translator has retrieved the filters associated with the received service identifications and parameters, the translator transmits the retrieved filters to a policy manager (e.g., the policy manager 106 of FIG. 1) (block 442). Then the example flowchart of FIG. 4 ends. The translator of the illustrated example awaits further service identifications and parameters for processing (e.g., control returns to block 402).

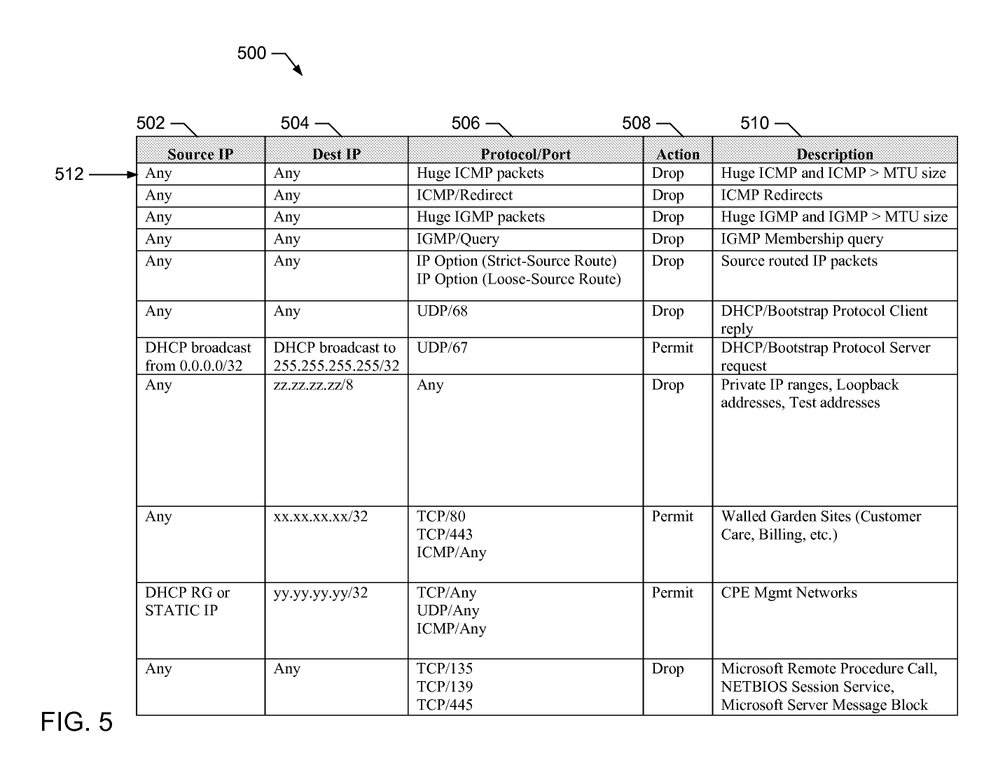

FIG. 5 illustrates an example table 500 of rules data that may be included in the example rules database 210. The example table 500 includes a source IP field 502, a destination IP field 504, a protocol/port field 506, an action field 508, and a description field 510. The example table 500 includes rules associated with a base set of rules for the service provider. An example first rule 512 specifies that any communication that includes large internet control message protocol (ICMP) packets to any destination is to be dropped (i.e., blocked).

FIG. 6 is a schematic diagram of an example processor platform 1000 that may be used and/or programmed to implement all or a portion of any or all of the ordering system 102, the translator 104, the policy manager 106, the residential gateway 108, the edge firewall 110, the service server 112, and the backbone firewall 114 of FIG. 1 and/or the service indicator receiver 202, the parameter receiver 204, the converter 206, the database retriever 208, the rules database 210, and/or the rule transmitter 212 of FIG. 2. For example, the processor platform 1000 can be implemented by one or more general purpose processors, processor cores, microcontrollers, etc.

The processor platform 1000 of the example of FIG. 6 includes at least one general purpose programmable processor 1005. The processor 1005 executes coded instructions 1010 and/or 1012 present in main memory of the processor 1005 (e.g., within a RAM 1015 and/or a ROM 1020). The processor 1005 may be any type of processing unit, such as a processor core, a processor and/or a microcontroller. The processor 1005 may execute, among other things, the example machine-readable instructions of FIG. 3 to implement the example methods and apparatus described herein.

The processor 1005 is in communication with the main memory (including a ROM 1020 and/or the RAM 1015) via a bus 1025. The RAM 1015 may be implemented by DRAM, SDRAM, and/or any other type of RAM device, and ROM may be implemented by flash memory and/or any other desired type of memory device. Access to the memory 1015 and 1020 may be controlled by a memory controller (not shown).

The processor platform 1000 also includes an interface circuit 1030. The interface circuit 1030 may be implemented by any type of interface standard, such as an external memory interface, serial port, general purpose input/output, etc. One or more input devices 1035 and one or more output devices 1040 are connected to the interface circuit 1030. The input devices 1035 and/or output devices 1040 may be used to, for example, implement the service indicator receiver 202, the parameter receiver 204, and/or the rule transmitter 212. For example, an example implementation the edge firewall 110 of FIG. 1 by the processor platform 1000 includes a network interface to implement the input devices 1035 and the output devices 1040. The network interface enables the example edge firewall 110 to, among other things, download coded instructions from a central server and communicate with devices on a service provider network (e.g., the example policy manager 106 of FIG. 1).

Of course, the order, size, and proportions of the memory illustrated in the example systems may vary. Additionally, although this patent discloses example systems including, among other components, software or firmware executed on hardware, such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein may be stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An apparatus for handling telecommunication service changes, the apparatus comprising:
a service indicator receiver to receive a first service indicator for a first service and to receive a second service indicator different from the first service indicator for a second service;
a converter to convert the first service indicator into a first set of service rules for the first service, to convert the second service indicator into a second set of service rules for the second service; and
a rule transmitter to send the first set of service rules and the second set of service rules to a network element.

2. An apparatus as defined in claim 1, wherein the first service is a television service.

3. An apparatus as defined in claim 2, wherein the television service is internet protocol television service.

4. An apparatus as defined in claim 1, wherein the first service is high speed internet service and the second service is one of internet protocol television service, voice over internet protocol phone service, or electronic mail transmission service.

5. An apparatus as defined in claim 1, wherein the network element is at least one of a policy manager, a firewall, or a residential gateway.

6. An apparatus as defined in claim 1, further comprising a parameter receiver to receive a parameter indicating a requested service level for the first service.

7. An apparatus as defined in claim 6, wherein the converter converts the first service indicator into the first set of services rules based on the parameter.

8. An apparatus as defined in claim 1, further comprising a database retriever to retrieve the first set of service rules from a database.

9. An apparatus as defined in claim 1, wherein the converter is further to sort the first set of service rules and the second set of service rules in a predetermined order.

10. An apparatus as defined in claim 9, wherein the predetermined order indicates that the first service is associated with an emergency service.

11. An apparatus as defined in claim 1, wherein the converter is further to:
determine that the first service is associated with an emergency service; and
sort the first set of service rules and the second set of service rules to cause the first set of service rules to override the second set of service rules.

12. A system for handling telecommunication service changes, the system comprising:
a telecommunication ordering server to receive a request to subscribe a user to a first service and to a second service;
a translator in communication with the ordering server to receive a first service indicator for the first service and to receive a second service indicator different from the first service indicator for the second service, the translator being structured to convert the first service indicator into a first set of service rules for the first service, and to convert the second service indicator into a second set of service rules for the second service; and
a policy manager in communication with the translator to receive the first set of service rules and the second set of service rules from the translator and to send at least one rule in the first set of service rules and the second set of service rules to at least one network element.

13. A system as defined in claim 12, wherein the first service is a television service.

14. A system as defined in claim 13, wherein the television service is internet protocol television service.

15. A system as defined in claim 12, wherein the first service is high speed internet service and the second service is one of internet protocol television service, voice over internet protocol phone service, or electronic mail transmission service.

16. A system as defined in claim 12, wherein the network element is a firewall or a residential gateway.

17. A system as defined in claim 12, wherein the translator is further to receive a parameter indicating a requested service level for the first service.

18. A system as defined in claim 17, wherein the translator is further to convert the first service indicator into the first set of services rules based on the parameter.

19. A system as defined in claim 12, wherein the translator is retrieve the first set of service rules from a database.

20. A system as defined in claim 13, wherein the translator is further to sort the first set of service rules and the second set of service rules in a designated order.

21. A system as defined in claim 20, wherein the designated order indicates that the first service is associated with an emergency service.

22. An system as defined in claim 13, wherein the translator is further to:
determine that the first service is associated with an emergency service; and
sort the first set of service rules and the second set of service rules to cause the first set of service rules to override the second set of service rules.

23. A method for handling telecommunication service changes, the method comprising:
receiving a first service indicator for a first service and a second service indicator different from the first service indicator for a second service; converting the first service indicator into a first set of service rules for the first service;
converting the second service indicator into a second set of service rules for the second service; and
sending the first set of service rules and the second set of service rules to a network element.

24. A method as defined in claim 23, wherein the first service is a television service.

25. A method as defined in claim 24, wherein the television service is internet protocol television service.

26. A method as defined in claim 23, wherein the first service is high speed internet service and the second service is one of internet protocol television service, voice over internet protocol phone service, or electronic mail transmission service.

27. A method as defined in claim 23, wherein the network element is at least one of a policy manager, a firewall, or a residential gateway.

28. A method as defined in claim 23, further comprising receiving a parameter indicating a requested service level for the first service.

29. A method as defined in claim 28, further comprising converting the first service indicator into the first set of services rules based on the parameter.

30. A method as defined in claim 23, further comprising retrieving the first set of service rules from a database.

31. A method as defined in claim 25, further comprising sorting the first set of service rules and the second set of service rules in a predetermined order.

32. A method as defined in claim 31, wherein the predetermined order indicates that the first service is associated with an emergency service.

33. A method as defined in claim 25, further comprising:
determining that the first service is associated with an emergency service; and
sorting the first set of service rules and the second set of service rules to cause the first set of service rules to override the second set of service rules.

34. A machine-readable medium storing machine-readable instructions that, when executed, cause a machine to:
receive a first service indicator for a first service and a second service indicator different from the first service indicator for a second service;
convert the first service indicator into a first set of service rules for the first service;
convert the second service indicator into a second set of service rules for the second service; and
send the first set of service rules and the second set of service rules to a network element.

35. A machine-readable medium as defined in claim 34, wherein the first service is a television service.

36. A machine-readable medium as defined in claim 35, wherein the television service is internet protocol television service.

37. A machine-readable medium as defined in claim 34, wherein the first service is high speed internet service and the second service is one of internet protocol television service, voice over internet protocol phone service, or electronic mail transmission service.

38. A machine-readable medium as defined in claim 34, wherein the network element is at least one of a policy manager, a firewall, or a residential gateway.

39. A machine-readable medium as defined in claim 34, wherein the machine-readable instructions, when executed, further cause the machine to receive a parameter indicating a requested service level for the first service.

40. A machine-readable medium as defined in claim 39, wherein the machine-readable instructions, when executed, further cause the machine to convert the first service indicator into the first set of services rules based on the parameter.

41. A machine-readable medium as defined in claim 34, wherein the machine-readable instructions, when executed, further cause the machine to retrieve the first set of service rules from a database.

42. A machine-readable medium as defined in claim 37, wherein the machine-readable instructions, when executed, further cause the machine to sort the first set of service rules and the second set of service rules in a predetermined order.

43. A machine-readable medium as defined in claim 42, wherein the predetermined order indicates that the first service is associated with an emergency service.

44. A machine-readable medium as defined in claim 37, wherein the machine-readable instructions, when executed, further cause the machine to:
determine that the first service is associated with an emergency service; and
sort the first set of service rules and the second set of service rules to cause the first set of service rules to override the second set of service rules.
